(19) United States
(12) Patent Application Publication
(10) Pub. No.: US 2016/0283944 A1
(43) Pub. Date: Sep. 29, 2016

(54) Method and apparatus for personal virtual authentication and authorization using digital devices and as an alternative for chip card or smart card

(71) Applicant: Mark O. Hubbard, South Bend, IN (US)

(72) Inventors: Mark O. Hubbard, South Bend, IN (US); Natalie M. Gunn-Stahl, Mishawaka, IN (US); Stuart G. Colianni, Naperville, IL (US); Abigail N. Huber, Gainsville, FL (US); Daniel S. Kestell, Dublin (IR); Anthony J. Musso, Cuyahoga Falls, OH (US)

(21) Appl. No.: 14/999,055

(22) Filed: Mar. 24, 2016

Related U.S. Application Data
(60) Provisional application No. 62/177,889, filed on Mar. 27, 2015.

(51) Int. Cl. G06Q 20/40; G06Q 20/32

(52) U.S. Cl. CPC G06Q 20/40145; G06Q 20/4012; G06Q 20/3224; G06Q 20/409

(57) ABSTRACT

A universal platform for personal, virtual authentication for use by digital devices for access to and/or permission, to confirm identity or enter into transactions (including e-commerce), premises and/or events by employing submitted samples of unique personal attributes which are compared with and evaluated against a library of similar pre-selected samples of unique personal attributes contained in multiple high-speed databases utilizing an internal virtual private network and secure two-way external data communications networks. The system provides for secure, contemporaneous and stored authentication credentials and a unique, secure coded transaction authorization message and record to subscribers as an equal or better alternative for and/or a complement to chip card technology without requiring a card, a physical token, additional hardware or a custom device.

This application claims priority from applicants' U.S. Provisional Patent Application No. 62/177,889 filed on Mar. 27, 2015, which is incorporated herein by reference.

### BACKGROUND OF THE INVENTION

1. Field of the Invention

The invention relates to a universal electronic platform for secure, personal, virtual authentication and authorization using digital devices which may be applied to or integrated into other platforms, systems and applications (apps) without requiring a proprietary card, token, computer chip or device. The invention will be an alternative to PIN and Chip (also known in Europe as EMV, Europay, Master Card, Visa), or Signature and Chip technology to meet the current European standard and to meet a new U.S. standard for authentication and authorization being implemented in October 2015. Generically, this is known in cyber industry circles as a “virtual smart card.”

2. Discussion of Related Art

Authentication is the process of identifying an individual, usually based on a username and password. Authentication is based on the idea that each individual user will have unique information that sets him or her apart from other users. (Webopedia)

Authorization is the process of granting or denying a user access to network resources once the user has been authenticated through the username and password. The amount of information and the amount of services the user has access to depend on the user's authorization level. (Webopedia)

Electronic authentication and authorization (hereafter “authentication” or “authenticate”) is utilized across a broad spectrum of digital platforms, systems and applications (apps) engaged in: establishing identity, administering financial records and transactions, point of sale (POS) commerce, remote commerce, e-commerce, consumer “e-wallets,” banking, payment systems, personal data protection, access to enterprise software and networks and physical access to lockable devices, vehicles and physical locations requiring security.

Electronic authentication and authorization and personal identity protection are distinct independent concepts which unfortunately are commonly equated. Personal identity data, especially in settings with connectivity through the Internet, have a high probability of being discovered and used without the owner's permission. It is estimated that 97% of adults in the U.S. have already had their personal identities compromised (CBS, 60 Minutes). Therefore, using personal identity data as a factor for secure authentication, which is a common practice, is inherently flawed from the outset.

The current commercial standard of electronic digital authentication for personal use is multi-factor (or multi-key) authentication requiring two or more active procedures that when successfully employed in combination serve to confirm user identity, enable digital transactional events and/or grant digital permission.

The simplest example of multi-factor authentication, and the most widely applied globally, is a combination of user name or account number (factor one) with a personal identification number (PIN), also referred to as a password or pass code (factor two).

Two-factor authentication is currently the commercial standard for a preponderance of digital identity protocols, financial transactions and commerce transactions, including e-commerce, conducted by individual users.

The two factors are frequently combined as a single, portable, plastic card application (loyalty, credit, debit or prepaid) which is physically examined, read by or presented to an electronic device to authenticate. In some instances additional information (PIN, printed batch security code, signature, personal information or proof of physical identity) may be requested of the user to complete a valid authentication.

Examples of additional personal information include, but are not limited to: address (home), address (work), telephone number(s), date of birth, place of birth, Social Security ID number, driver's license number, auto/boat/vehicle registrations, utility (power, gas, water) account numbers and mother's maiden name. In some cases, personal information extends to include personal preferences, such as, but not limited to: favorite vacation spot, pet name, make of first car, and favorite athletic team. Personal information is subject to discovery through multiple methods of identity fraud and therefore not considered secure.

Two-factor authentication as commonly used by consumers/users in the U.S. is acknowledged by cyber security experts to be weak and easily hacked by malicious parties and therefore subject to being counterfeited. This is because: 1) the user name or account number is often exposed (may be printed or embossed on a card itself) or easily discovered through public sources, 2) the PIN (passwords or codes) selected by users are often selected for ease of user memory and may be discovered or guessed by trained cyber hackers with relative ease, and 3) malware programs, including those that spy on device keystrokes, may uncover both user name and password remotely with ease and usually without user detection. Moreover, subscriber (those requiring authentication) databases that hold personal information for comparison to user-supplied information in the authentication process are demonstrably vulnerable to hacks achieved when subscriber networks are breached, such as at Target.

Personal usage of traditional loyalty, credit and debit cards with magnetic strips (the US standard on Jan. 1, 2015) fails to provide adequate secure authentication protection. This is because the account number is customarily exposed (printed or embossed) on the plastic card along with the user's name. This information and additional user information is also recorded without encryption on the magnetic strip which is easily read by commonly available card reader devices (most retailers have these and some are commercially available for personal use).

Lost or stolen cards represent a significant opportunity for authentication fraud. This is the vulnerability that most users understand and guard against. Unfortunately, without the physical card being either lost or stolen the user is unknowingly vulnerable to the same level of authentication fraud when the required user authentication data are discovered by other means.

Authentication for Government documents privileges and benefits is very often done remotely and increasingly encouraged to be on line (Social Security, Medicare, Affordable Care Act, welfare, food stamps, voting) and relies on outdated multi-factor protocols. Therefore the incidence of cyber crime and theft in these programs is substantial, but difficult, some would say impossible, to police or quantify.

Requesting a three or four digit batch “security number” printed on a card fails to add significantly to security because there are mathematically a limited number of variations which may be entered electronically and tested robotically with incredible speed by determined cyber hackers.

To improve two-factor authentication, “PIN and chip” cards have been the commercial standard for loyalty, credit and debit transactions in the Europe for more than 15 years. This is because the European banking system has adhered to a higher authentication standard than in the US.

The more advanced “chip-and-PIN” technology has been adopted in Europe, Australia and Canada. The U.S. is one of the few developed countries not to embrace it. (“New Credit Cards Fall Short on Fraud Control,” Wall Street Journal, Jan. 5, 2015)

PIN and Chip cards have been credited with a 33% decline in overall card fraud in the United Kingdom since their introduction. But e-commerce fraud actually increased. (Associated Press, Dec. 22, 2013, Hackers target U.S. Credit cards because of outdated security)

Because of regulatory changes governing card fraud protection, chip cards are being introduced as the new standard into the US.

This year, firms ranging from J.P. Morgan Chase & Co. to Discover Financial Services Inc. are expected to roll out more than a half-billion new credit cards embedded with computer chips that create a unique code for each transaction, making counterfeiting much more difficult (“New Credit Cards Fall Short on Fraud Control,” Wall Street Journal, Jan. 5, 2015)

New regulatory standards governing card security become effective on Oct. 1, 2015.

Financial institutions are motivated to bolster security, as they are typically on the hook for unauthorized transactions. That will change in October when merchants who don't have the upgraded technology to accommodate chip cards will be responsible for the cost of any fraud that occurs when one of the cards is used. (“New Credit Cards Fall Short on Fraud Control,” Wall Street Journal, Jan. 5, 2015)

Chip and signature cards, not PIN and Chip cards appear to be the current solution of choice by many U.S. card issuers starting in 2015.

Big U.S. banks are steering clear of an advanced security measure used in credit cards around the world, opting for a system that is more convenient for shoppers but may leave them vulnerable to fraud.
In a retreat for the industry, however, the new cards don't use some technology that could prevent fraud if a card is lost or stolen.
Instead of requiring customers to put in a personal identification number, or PIN, the new cards need users to authenticate credit-card transactions the same way they often do now, with a signature. PINs are widely considered to be more secure than signatures, which can be easily copied. (“New Credit Cards Fall Short on Fraud Control,” Wall Street Journal, Jan. 5, 2015)

The introduction of either Chip and signature or PIN and Chip cards in the US won't necessarily add significant levels of card fraud protection for the foreseeable future. Many current examples of these cards will continue to employ exposed name and account numbers and magnetic strips containing private user information. The weaknesses of these elements will negate the effectiveness of chip technology for as long as they are retained.

The new chip cards also contain the old-fashioned magnetic stripe to accommodate merchants who don't have the new technology. (“New Credit Cards Fall Short on Fraud Control,” Wall Street Journal, Jan. 5, 2015)

Compromised cards are likely to be honored for a long period of time because point of sale (POS) transactions systems are not equipped with the necessary more advanced chip card readers.

In addition, until digital devices like personal computers, smart phones and wearable items are equipped with chip card readers, e-commerce will continue to depend on existing authentication methods which don't meet the new standard.

The PIN system is only a defense for point-of-sale purchases and doesn't provide additional protection for online sales. (“New Credit Cards Fall Short on Fraud Control,” Wall Street Journal, Jan. 5, 2015)

In theory, the strongest form of PIN and chip authentication would employ an isolated chip located on, or embedded into a person, without exposing any additional identity data. This is technically difficult to accomplish, but also socially and economically impractical to implement at the present time or in the foreseeable future.

In authentication security the fundamental tension governing card issuer decisions when selecting authentication methods is between higher levels of security weighted against acceptable levels of consumer convenience and the cost of implementation.

Consumers are unlikely to demand Government intervention for increased authentication security unless they are personally and directly liable for losses due to misuse or fraud as a result of their acceptance of lower convenient levels of security. This may change in the future if regulations become necessary to better protect consumers and their identities.

Adding incidental requirements for authentication to chip cards, such as personal information or answers to personal questions, is a disguised and vain attempt to increase the perception of, but not the reality of, security and reduce fraud for the reasons previously cited [0010].

Methods of authentication which depend on personal information (including signatures, fingerprints, facial recognition or other biometrics) are frequently subject to cyber crime attacks. Most sophisticated hacks of government and retail systems have been accomplished by invading computer networks which, when hacked, expose databases where personal user information is stored. These include well-documented cases at: Target, Walmart, Home Depot, Marshalls, TJ Maxx, Neiman-Marcus, Sony, Chick-fil-a, Anthem and various Government agencies.

Credit card fraud is a significant financial issue that threatens all retailing in the U.S. and is a drain across multiple sectors of the national economy.

U.S. credit-card-fraud losses totaled roughly $18 billion in 2013, according to Javelin Strategy & Research, a consulting firm that is a unit of Greenwich Associates. About a third of those losses are attributed to counterfeit cards, according to consulting firm Aite Group. (“New Credit Cards Fall Short on Fraud Control,” Wall Street Journal, Jan. 5, 2015)

False authentication to establish identity or eligibility for Government benefits is a significant danger and a financial cost to society. It is impossible to accurately measure the extent of this category of fraud, but it is likely to be many billions of dollars annually.

Enterprises (especially those engaged in commerce), agencies and organizations that depend on secure electronic authentication and authorization are seeking a comprehensive universal platform which: 1) provides the same, or better, multi-levels of security as PIN and Chip and meets the current European standard and meets the new U.S. standard, 2) does not require a physical token (card) or a device that exposes a user's name, account number or other personal information, 3) provides secure functionality for e-commerce and other remote applications, 4) does not require a new generation of personal computers, personal devices or smart phones with card readers to provide security, 5) does not hold personal information for authentication credentials in a database which is hackable through network intrusions, and 6) provides sufficient convenience for users to consistently use with confidence.

OmniGarda is proposing a novel and non-obvious solution to address the requirements outlined above [0031].

The OmniGarda platform may be flexibly used as; 1) the primary from of authentication for a significant number of users, 2) the preferred or required form of authentication for high-value transactions or purposes, 3) a secondary or back-up form of authentication as situations dictate, 4) an additional factor in combination with other security factors or 5) the default form of authentication as a matter of convenience for lost or stolen cards.

### SUMMARY OF INVENTION

The present invention provides a method of generating secure personal user authentication and authorization credentials and a subscriber electronic authentication and authorization platform network having an administration engine, a registration engine, a sample clarification engine, a sample scoring engine, a permission granting engine, a platform transaction records database and a personal storage vault that provides an individual user with digital access, identity and/or permission to transact events and creates a unique alpha-numeric event/transaction record code while conveniently achieving functionality that is extremely difficult to replicate by unauthorized users.

Subscribers to the invention are those parties who employ authentication and authorization by OmniGarda as elements of their digital platform(s), device(s) and protocol(s) to securely implement valid access and enable transactions and events.

Users/consumers (including commerce consumers) of the invention are those parties who utilize authentication and authorization by OmniGarda to achieve a digital processes and outcomes provided by, or made available by or through subscribers.

Administrators of the invention are OmniGarda, or parties authorized by OmniGarda, to implement the installation of the platform network and to make changes, alterations and improvements to the apparatus and methods as necessary to insure quality control, functionality, integrity and convenience.

### Subscriber Initiation

For each valid subscriber, administrators enter a catalogued library of randomly selected personal attribute samples through the platform administration engine by virtual private network (VPN) to the clarification engine which are stored as sample library data in database(s).

The platform performs optimally using a specialized type of low-latency, high-volume tunneling database, such as the JustOne relational database provided by JustOneDatabase, Inc. disclosed in United States Patent Application, Pub. No. US 2011/0252073 A1. But this in not required.

The first preferred embodiment of the invention is for subscriber to use the OmniGarda platform as a cloud based service to subscribers with applications to their users and to the parent subscriber.

The second preferred embodiment of the invention is for the subscriber to use the OmniGarda platform as an enterprise product with applications to their users and to the parent subscriber.

Subscribers provide the OmniGarda platform with conforming specifications and API(s) (applied program interface) for administrators to establish a subscriber account and protocols through which users may register and attempt to authenticate.

### Users Registering for Authentication Privileges

Users registering for or requesting personal authentication services through the OmniGarda platform require the submission of a unique PIN (personal identification number) to accompany digital sample(s) establishing unique personal physical attributes.

User(s) provide(s) the OmniGarda platform with digital sample(s) of unique personal physical attributes collected through subscriber devices and protocols, or through a subscriber authorized digital source such as computer, smart phone, kiosk, wearable device, sensor or medical device. Examples of unique personal physical attributes include, but are not limited to: still and moving pictures, fingerprints, bio-metrics, voice prints, biological markers and other permanent physical personal identifiers.

In accordance with the invention, samples of unique personal physical attributes with PIN are submitted by user(s) through the subscriber control engine to the platform's administration engine and registration engine using secure communications employing non-platform, subscriber-authorized, digital devices over secure communications channels selected by subscriber.

In accordance with the invention, the registration engine verifies the user PIN as being unique to the subscriber's version of the platform and verifies the personal sample as being current, within pre-established parameters and of a quality sufficient for submission to the platform. The subscriber will receive a return message through the established initial communication path regarding the status of the submitted PIN and sample, and they in turn may pass a message to user.

Upon successful submissions to the registration engine both the PIN and the unique personal physical attribute sample(s) are linked, with platform metadata tags inserted, in a file and forwarded to the sample clarification engine using the platform's virtual private network (VPN).

The sample clarification engine performs security check(s) on the data to ascertain that the initial sample data are free of any malware (virus, worms, cookies, etc.). The subscriber will receive a return message through the established initial communication path regarding the status of the submitted file.

When free from malware, the sample data from the file are processed by the sample clarification engine to create a standardized version(s) using such parameters as: orientation, file size, dimensions, magnification and format. The standardized version(s) of the initial sample data are then reconfigured through a series of protocols and algorithms to create a reconfigured standardized sample file with PIN and metadata tags.

The reconfigured standardized sample with PIN is saved as data and forwarded through the VPN to the sample scoring engine. Previous personal file data no longer required in the authentication process are then permanently erased.

The sample scoring engine compares the user's reconfigured sample against each entry in the pre-loaded sample library data of cataloged clarified composite samples from the sample clarification engine to generate a coded alphanumeric “score” as to how similar (or dissimilar) the user's reconfigured standardized sample is to each library clarified composite sample.

The sample scoring engine records the “scores” of the user's reconfigured standardized sample with PIN for all library entries as the user's temporary baseline sample scores data with PIN.

The temporary baseline sample data is processed in the sample scoring engine using algorithms that flatten the “bell curve effect” on data and further manipulates data to achieve permanent baseline sample data with PIN for the user matched to every entry in the library.

The sample scoring engine saves the permanent baseline sample scores with PIN and metadata tags for every element of the library as composite sample scores data with PIN in database(s). Previous file data not forwarded in the process are then permanently erased.

### User Requesting Authentication by Event

In accordance with the invention, users requesting or requiring secure authentication and authorization by the subscriber submit their PIN and a contemporaneous sample for each authentication event. An authentication event may be a contemporaneous situation requiring immediate authentication or a stored authentication for a future event as managed by subscriber. This sample is processed through the OmniGarda platform following the protocols above (steps [0045]-[0051]).

The sample scoring engine compares the user's reconfigured sample with PIN against a randomly selected set of entries in the pre-loaded library of cataloged clarified composite samples from the sample clarification engine to generate a coded alpha-numeric “score” as to how similar (or dissimilar) the user's reconfigured standardized event sample is to each library clarified composite sample from the randomly selected set of entries.

The sample scoring engine records the “scores” of the user's reconfigured standardized sample with PIN for each entry in the library set as the user's event temporary baseline sample scores data with PIN.

The event temporary baseline sample data is processed in the sample scoring engine using algorithms that flatten the “bell curve effect” on data and further manipulates data to achieve event permanent baseline sample data with PIN for the user matched to every entry in the library set.

The sample scoring engine saves the permanent baseline sample scores with PIN for every element of the library set in advanced high-speed database(s). Previous file data no longer required in the event authentication process are permanently erased.

The sample scores engine compares the event baseline sample scores data with PIN for the library set against the baseline sample library data with PIN for the like library set and produces an accuracy score for each comparison.

The number of comparisons from the library set in the process is pre-determined by the level of security required. More comparisons mathematically yield higher degrees of security. (With a multitude of comparisons it may be possible to simply use a user/consumer name as a the PIN and rely on the mathematical power of comparing physical samples of unique personal attributes.)

If the user's event baseline sample scores with PIN and metadata tags are definitively inaccurate when matched against all the event scores from the composite sample scores library set, permission for the user event authentication credentials is denied.

If the user's event baseline sample scores with PIN and metadata tags are definitively accurate when matched against all the event scores from the composite sample scores library set, permission for the user event authentication credentials is approved.

If the user's event baseline sample scores with PIN and metadata tags are definitively deemed in error or inconclusive when matched against all the event scores from the composite sample scores library set, permission for the user event authentication credentials is withheld temporarily. Another set of clarified sample library data is added incrementally repeating the process from [0052] to for the event authentication. If after three additional cycles of the process the comparisons remain inconclusive for the accuracy match the user event authentication credentials are denied.

Notice of approved or denied event authentication credentials will be provided to the subscriber and they in turn may pass a message to the user through the established initial communication path.

### Event Authorization

In accordance with the invention, approved event authentication credentials with PIN and platform metadata tags are forwarded to the permission granting engine using the VPN.

The permission granting engine receives the approved authentication credentials and determines the disposition of user authentication credentials under one, or more, of three possibilities.

Event authentication credentials may entitle the user to advance by VPN to the platform-to-subscriber application program interface (API), and then through encrypted communication to the subscriber control engine that grants secure event authentication to an external application (transaction, access, permission, etc.).

Event authentication credentials may entitle the user to advance by VPN to the platform-to-subscriber application program interface (API), and then through encrypted communication to the subscriber control engine that grants one or more secure stored event pre-authentications to future external applications (transaction, access, permission, etc.).

Event authentication credentials may entitle the user advance to a secure vault application internal to the OmniGarda platform through the platform VPN that enables limited storage of user personal secret data, such as important identification numbers, documents, codes and account numbers.

### BRIEF DESCRIPTION OF THE DRAWINGS

The invention will be better understood when the description of preferred embodiments provided below is considered with the figures provided, wherein:

FIG. 1 is a diagrammatic overview of platform apparatus in accordance with a first preferred embodiment of the present invention as a cloud-based service showing connections between subscribers, users, communications devices, websites and platform including the administration engine, registration engine, sample clarification engine, sample scoring engine, permission granting engine, personal storage vault, data archive for transactions records, platform VPN engine and platform-to-subscriber interface.

FIG. 1A is a diagrammatic overview of platform apparatus in accordance with a second preferred embodiment of the present invention as an enterprise product showing connections between subscribers, users, communications devices, websites and backbone center including the administration engine, registration engine, sample clarification engine, sample scoring engine, permission granting engine, personal storage vault, data archive for transactions records, platform VPN engine and platform-to-subscriber interface.

FIG. 2 is a flowchart of a method for administration of subscriber initiation of an account and sample libraries in accordance with the invention;

FIG. 3 is a flowchart of a method for users registering for authentication privileges in accordance with the invention;

FIG. 4 is a flowchart of a method for users requesting authentication by event in accordance with the invention.

FIG. 5 is a flowchart of a method for transferring authentication credentials as event authorizations in accordance with the invention.

In these figures, similar items have the same index numbers.

### DETAILED DESCRIPTION OF PRESENTLY PREFERRED EMBODIMENTS

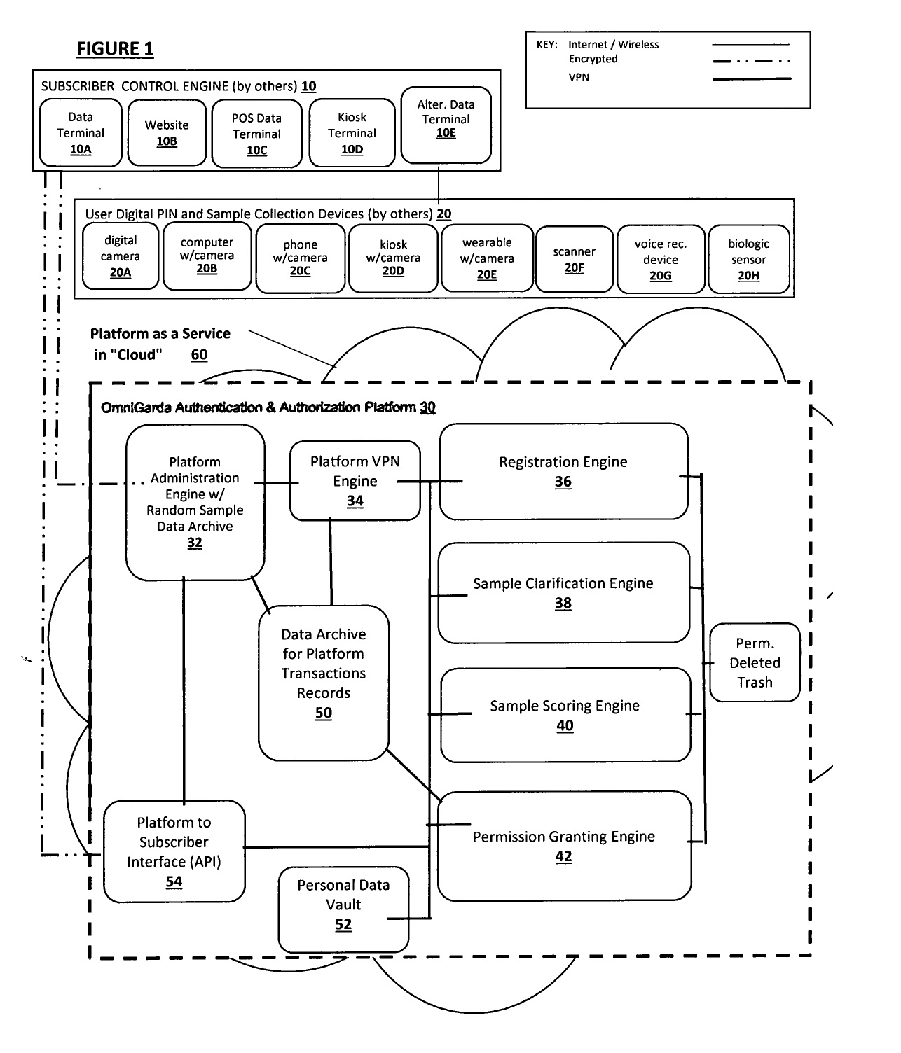

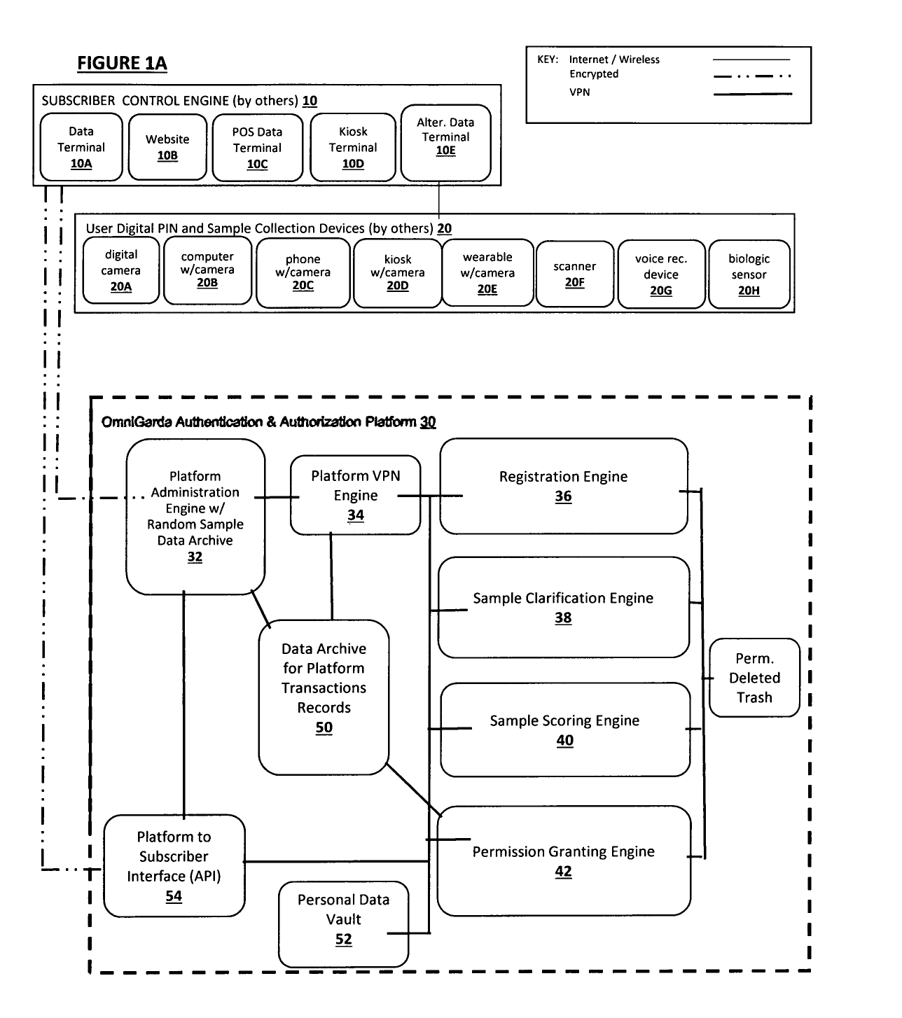

In FIG. 1, an electronic authentication and authorization platform 30 in accordance with a first preferred embodiment of the invention is established by OmniGarda as a cloud-based service to subscribers 60.

In FIG. 1A, and electronic authentication and authorization platform 30 in accordance with a second preferred embodiment of the invention is established by OmniGarda as an integrated enterprise product to subscribers.

Both the first and second preferred embodiments, FIGS. 1 and 1A, of the invention have the same apparatus (except as noted above) and hereafter may be referred to interchangeably as the “OmniGarda platform” 30 or “the platform.”

### Subscriber Initiation

FIG. 1 shows how a subscriber through their control engine(s) 10 may initiate, communicate with and utilize the platform. Through a subscriber data terminal (computer) 10A the subscriber may communicate with the platform administration engine 32 with guidance to utilize the platform and to conform to platform protocols. The subscriber may also be in control of, or have authorized, websites 10B, point of sale terminals 10C and kiosks 10D and other alternative types of data terminals 10E, which, as subscriber-permissioned control engines, may also be designated to communicate directly and securely with the platform administration engine 32.

Subscribers authorized to use the platform by the platform administration engine 32 may include, but aren't limited to: card issuers, retailers, e-commerce sites, financial institutions, government entities, fixed physical premises, mobile premises, vehicles, and other subscriber platforms and services where secure authentication is a necessary or desired component of product or service delivery.

Subscriber uses one or more elements of the subscriber control engine 10 to communicate with, manage and enable their authorized users through user digital PIN and sample collection device(s) 20, which may be provided by the subscribers or by others and are not part of the platform. These devices typically communicate directly with the subscriber control engine 10. With subscriber permission these digital devices may be enabled to communicate with the platform through the subscriber control engine 10. These devices may include, but aren't limited to: digital still and/or moving picture camera 20, computer with digital still and/or moving picture camera 20B, fixed or mobile telephone with still and/or moving picture camera 20C, kiosk with still and/or moving picture camera 20D, personal wearable devices including those with still and/or moving picture camera 20E, scanners 20F, voice recognition devices, including those which may be integrated into other digital devices 20G and biologic and medical sensors, including those which may be integrated into other digital devices 20H.

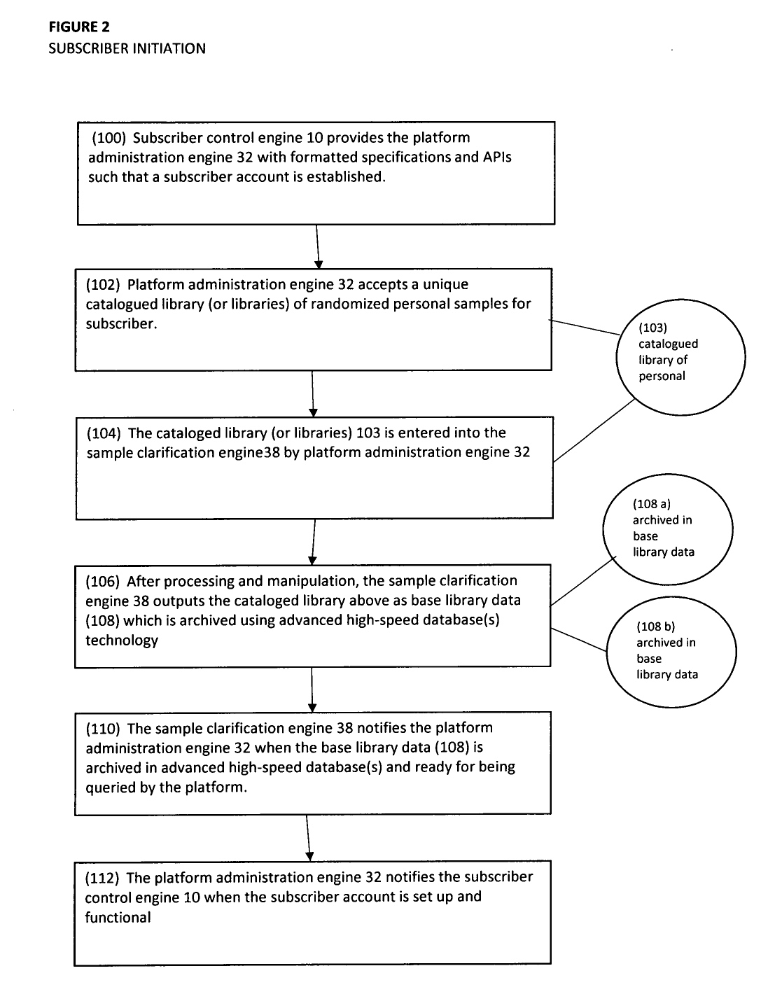

As shown in FIG. 2, 100, subscriber control engine 10 provides the platform administration engine 32 with OmniGarda platform approved, conforming and formatted specifications and APIs such that a subscriber account is established.

As shown in FIG. 2, 102, the platform administration engine 32 accepts the OmniGarda assembled large (minimum 1000 entries) catalogued library (or libraries) 103 of randomized, unique personal samples as data, of persons without attached identities, or of artificial personas created for library inclusion, for subscriber.

A preferred embodiment of the invention is to use a library of facial images that approximate the diversity of the subscriber's potential target users across multiple variables, such as, but not limited to: gender, age, ethnicity, size, composition and deformities or irregularities.

A second preferred embodiment of the invention is to use a library of human hand or fingerprint images that approximate the subscriber's potential target users across multiple variables, such as, but not limited to: gender, age, ethnicity, size, composition and deformities or irregularities.

Possible other embodiments of the invention use libraries of digital human data samples that approximate the subscriber's potential target users across multiple variables, such as, but not limited to: bio-metrics, voice prints, biological markers and other physical personal identifiers.

As shown in FIG. 2, 104, the cataloged library (or libraries) 103 is entered into the sample clarification engine 38 as sample library data by administration engine 32.

As shown in FIG. 2, 106, after processing and manipulation, the sample clarification engine 38 outputs the cataloged library above as base library data and archives it in database(s) 108 which is integral to the sample clarification engine 38.

As shown in FIG. 2, 110, utilizing the platform VPN, the sample clarification engine 36 notifies the administration engine 32 when the base library data 108 is archived in advanced high-speed database(s) and available for being queried by the platform.

As shown in FIG. 2, 112, the platform administration engine 32 notifies the subscriber control engine 10 when the subscriber account is set up and functional.

### Users Registering for Authentication Privileges

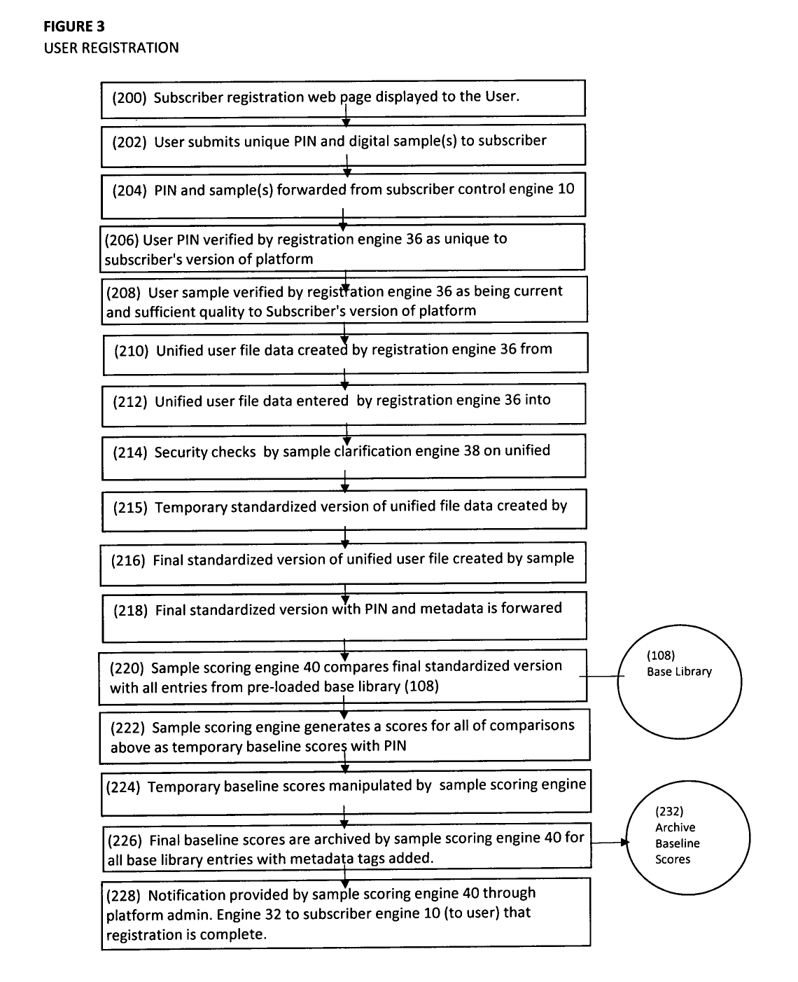

In accordance with the invention, users may register in the subscriber's version of the platform through the subscriber control engine 10. As shown in FIG. 3, the subscriber's registration web page is displayed to the user 200.

As shown in FIG. 3, 202, using a sample collection device 20, a user submits a unique PIN and digital sample(s) to the subscriber's control engine 10 which verifies the user as having a subscriber account and being eligible for OmniGarda authentication.

As shown in FIG. 3, 204, the PIN and sample(s) from eligible users are forwarded by the subscriber control engine 10 to the platform and entered from the administration engine 32 into the registration engine 36.

In accordance with the invention, samples of personal uniqueness originate from non-platform, subscriber authorized digital devices 20 that are programmed to collect and forward valid samples through two-way electronic communications, including Internet and other digital service platforms, including those using encryption. These devices include, but are not limited to: cameras 20A, video cameras 20A, computers 20B, smart phones 20C, scanners 20F, sensors 20H, kiosks 20D, point-of-sale checkout devices and custom data collectors or digital devices for which one of the aforementioned capabilities is a component.

Users registering for personal authentication credential services through the platform require the submission of a unique PIN (personal identification number) and digital sample(s) establishing personal uniqueness to log on as users of the OmniGarda platform. Samples of personal uniqueness shall include, but are not limited to: photographic images, moving pictures, voice prints, signatures, biometric markers, fingerprints, or medical samples, including DNA.

A preferred embodiment of the invention is to use personal sample(s) collected as event-contemporaneous facial photographs or moving pictures, also generically known as “selfies.”

A second preferred embodiment of the invention is to use personal sample(s) collected as event-contemporaneous fingerprints or handprints.

As shown in FIG. 3, 206, user PIN verified by registration engine 36 as being unique to subscriber's version of platform.

In the event that the PIN is not unique the user may provide an alternate PIN until a unique PIN is accepted by the registration engine 36, or the user or the subscriber may terminate the authentication registration request. The user will receive a return message from the subscriber control engine 10 through the established initial communication path regarding the status of the submitted PIN.

In accordance with the invention, the registration engine 36 verifies the personal sample as being current within pre-established parameters and of a quality sufficient for submission to the platform. In the event that the personal sample is not current or of sufficient quality the user may employ a limited number of attempts within pre-established parameters to provide a valid personal sample. The user will receive a return message from the subscriber control engine 10 through the established initial communication path regarding the status of the submitted personal sample.

As shown in FIG. 3, 208, user sample verified by registration engine 36 as being current, of sufficient quality and conforming to subscriber's version of platform.

As shown in FIG. 3, 210, unified user file data created in registration engine 36 combining valid user PIN and sample(s).

As shown in FIG. 3, 212, unified user file data entered by registration engine 36 through VPN into sample clarification engine 38.

As shown in FIG. 3, 214, additional security checks are performed by sample clarification engine 38 on unified user file data.

As shown in FIG. 3, 215, when free from malware, the sample data are processed by the sample clarification engine 38 to create a temporary standardized version using such parameters as: orientation, file size, dimensions and format.

As shown in FIG. 3, 216, the standardized version(s) of the initial sample data are then reconfigured through a series of protocols and algorithms and the sample clarification engine 38 creates a final standardized sample file with PIN and metadata tags added. All unused data in the registration process are deleted by the sample clarification engine 38.

As shown in FIG. 3, 218, the final standardized version with PIN and metadata tags is forwarded by sample clarification engine 38 through VPN to sample scoring engine 40.

As shown in FIG. 3, 220, the sample scoring engine 40, compares the standardized version with PIN individually with every entry from the pre-loaded base library stored in the sample clarification engine 38.

As shown in FIG. 3, 222, the sample scoring engine 40 generates a comparative score for each comparison made above as a referenced set of temporary baseline scores with PIN and metadata tags.

As shown in FIG. 3, 224, the temporary baseline scores from the set of scores are further manipulated by the sample scoring engine (40) to yield achieve a flattened bell curve for each temporary baseline score with PIN in the set to create final baseline scores with PIN and metadata tags.

As shown in FIG. 3, 226, final baseline scores are archived by sample scoring engine 40 as a set of referenced final baseline scores for all baseline library entries with PIN and metadata tags. All previous data in the registration process not in use are deleted by the sample clarification engine 40.

As shown in FIG. 3, 228, notification is provided by the sample scoring engine 40, through VPN to the administration 32 to subscriber control engine 10 which is responsible for informing the user when a registration is successfully completed, or if a registration fails and needs to be repeated.

### User Requesting Authentication by Event

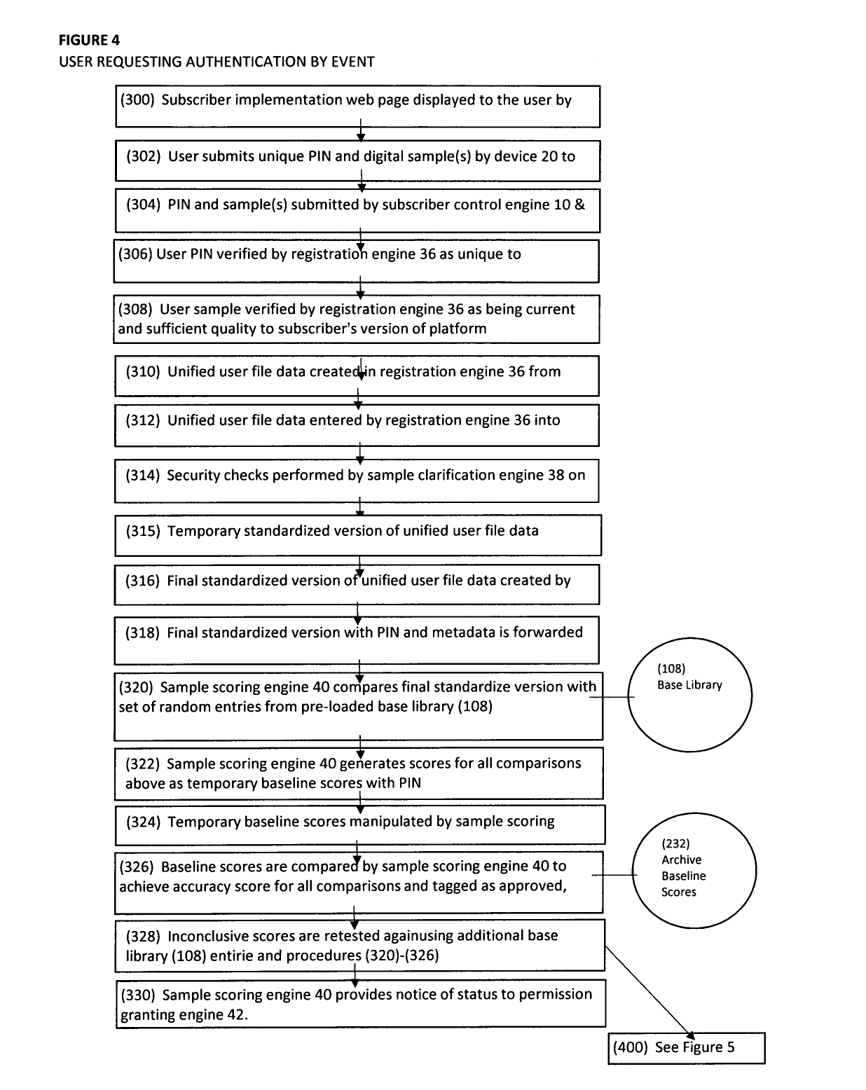

In accordance with the invention, users may request authentication credentials through a subscriber's version of the platform through the subscriber control engine 10. As shown in FIG. 4, the subscriber implementation web page is displayed to the user 300.

As shown in FIG. 4, 302, using a sample collection device 20, a user submits a unique PIN and digital sample(s) to the subscriber's control engine 10 which verifies the user as having a subscriber account and being eligible for OmniGarda authentication.

As shown in FIG. 4, 304, the PIN and sample(s) from eligible users are forwarded by the subscriber control engine 10 to the platform and entered from the administration engine 32 into the registration engine 36.

In accordance with the invention, samples of personal uniqueness originate from non-platform, subscriber authorized digital devices that are programmed to collect and forward valid samples through two-way electronic communications, including Internet and other digital service platforms, including those using encryption. These devices include, but are not limited to: cameras, video cameras, computers, smart phones, scanners, sensors, kiosks, point-of-sale checkout devices and custom data collectors or digital devices or which one of the aforementioned as a component.

Users requesting personal authentication credentials through the platform require the submission of a unique PIN (personal identification number) and digital sample(s) establishing personal uniqueness to log on as users of the OmniGarda platform. Samples of personal uniqueness shall include, but are not limited to: photographic images, moving pictures, voice prints, signatures, biometric markers, fingerprints, or medical samples, including DNA.

A preferred embodiment of the invention is to use personal sample(s) that are consistent with the platform registration process collected as event-contemporaneous facial photographs or moving pictures, also generically known as “selfies.”

A second preferred embodiment of the invention is to use personal sample(s) that are consistent with the platform registration process collected as event-contemporaneous fingerprints or handprints.

As shown in FIG. 4, 306, user PIN verified by registration engine 36 as being unique to subscriber's version of platform.

In the event that the PIN is not unique the user may provide an alternate PIN until a unique PIN is accepted by the registration engine 36, or the user or the subscriber may terminate the authentication request. The user will receive a return message from the subscriber control engine 10 through the established initial communication path regarding the status of the submitted PIN.

In accordance with the invention, the registration engine 36 verifies the personal sample as being current within pre-established parameters and of a quality sufficient for submission to the platform. In the event that the personal sample is not current or of sufficient quality the user may employ a limited number of attempts within pre-established parameters to provide a valid personal sample. The user will receive a return message from the subscriber control engine 10 through the established initial communication path regarding the status of the submitted personal sample.

As shown in FIG. 4, 308, user sample verified by registration engine 36 as being current, of sufficient quality and conforming to subscriber's version of platform.

As shown in FIG. 4, 310, unified user file data created in registration engine 36 combining valid user PIN and sample(s).

As shown in FIG. 4, 312, unified user file data entered by registration engine 36 through VPN into sample clarification engine 38.

As shown in FIG. 4, 314, additional security checks are performed by sample clarification engine 38 on unified user file data.

As shown in FIG. 4, 315, when free from malware, the sample data are processed by the sample clarification engine 38 to create a temporary standardized version(s) using such parameters as: orientation, file size, dimensions and format.

As shown in FIG. 4, 316, the standardized version(s) of the initial sample data is then reconfigured through a series of protocols and algorithms and the sample clarification engine 38 creates a final standardized sample file with PIN and metadata tags. All previous data in the registration process no longer in use are deleted by the sample clarification engine 38.

As shown in FIG. 4, 318, the standardized version with PIN is forwarded by sample clarification engine 38 through VPN to sample scoring engine 40.

As shown in FIG. 4, 320, the sample scoring engine 40, compares the standardized version with PIN individually with a limited set of randomly selected entries from the pre-loaded base library archived in the sample clarification engine 38.

As shown in FIG. 4, 322, the sample scoring engine 40 generates a comparative score for each comparison made on the above set of randomly selected entries as a referenced set of temporary baseline scores with PIN.

As shown in FIG. 4, 324, the temporary baseline scores from the set of scores are further manipulated by the sample scoring engine (40) to yield a flattened bell curve score for each temporary baseline score which becomes the final baseline score for each entry with PIN in the set.

As shown in FIG. 4, 326, final event baseline scores are archived as a set of referenced final baseline event scores for the base library entries. All previous files in the event authentication process are deleted by the sample scoring engine 40.

As shown in FIG. 4, 328, the sample scoring engine 40 compares the event baseline sample scores data with PIN for the library set against like entries from the baseline sample library data with PIN from the like library set and produces an accuracy score for each comparison.

The number of comparisons in the process is pre-determined by the level of security required. More comparisons mathematically yield higher degrees of security.

If the user's event baseline sample scores with PIN are definitively inaccurate when matched against all the event scores from the baseline sample scores library set, permission for user event authentication credentials is tagged as denied. All previous data are permanently erased.

If the user's event baseline sample scores with PIN are definitively accurate when matched against all the event scores from the baseline sample scores library set, permission for user event authentication credentials is tagged as approved. All previous data are permanently erased.

If the user's event baseline sample scores with PIN and metadata tags are definitively deemed inconclusive when matched against all the event scores from the composite sample scores library set, permission for the user event authentication credentials is withheld temporarily. Another set of clarified sample library data is added incrementally repeating the process from [0133] to for the event authentication. If after three additional cycles of the process the comparisons remain inconclusive for the accuracy match the user event authentication credentials are denied. All previous data are permanently erased.

As shown in FIG. 4, 330, notice of the tagged outcomes and the comparative scores of the scoring process above with PIN are forwarded by the sample scoring engine 40 to the permission granting engine 42 through the VPN. All previous data no longer required in the event authentication process are deleted by the sample scoring engine 40.

### Event Authorization

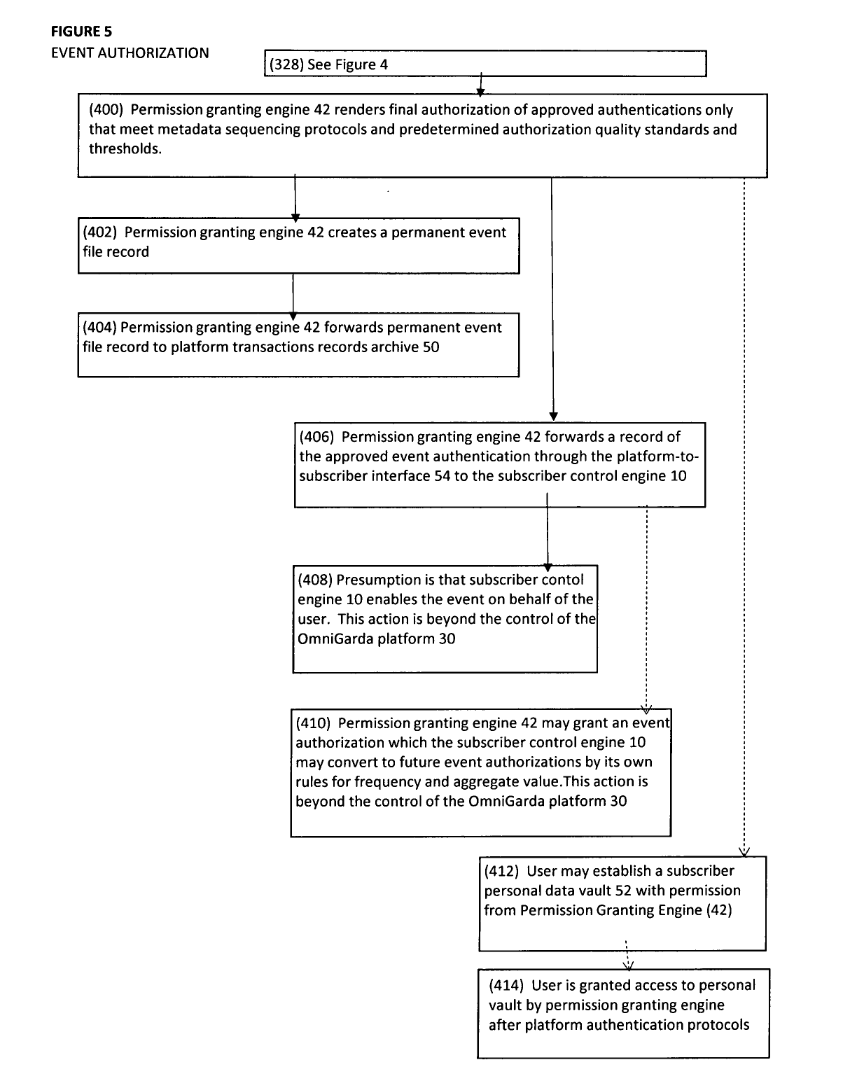

As shown in FIG. 5, (400), the permission granting engine 42 renders a final determination of tagged outcomes and the comparative scores with PIN by evaluating them to predetermined subscriber authorization quality standards. If the quality threshold is achieved and metadata sequencing protocols are met authentication is approved and authorization is granted. If not, authentication and authorization are rejected.

As shown in FIG. 5, (402), the permission granting engine 42 creates a permanent file record for the approved (and denied) authentications using a unique alpha-numeric code, per platform-secret protocols, to record the authentication event in a searchable format by: subscriber, PIN, level of security, date and time, and other data as requested by subscriber.

As shown in FIG. 5, (404), permission granting engine 42 forwards the event authentication record to the platform transactions records data archive (50) using VPN.

As shown in FIG. 5, (406), the permission granting engine(42) forwards a record of the approved event authentication and authorization through the platform to the subscriber interface (API) 54, then on to the subscriber control engine 10 through a secure encrypted path and in a format pre-determined by the subscriber for their internal use.

As shown in FIG. 5, 408, the presumption is that holding the approved event authentication and authorization the subscriber control engine 10 enables the event on behalf of the user. This action is beyond the control of the OmniGarda platform 30.

As shown in FIG. 5, 410, in one embodiment of the invention, at the election of the subscriber, the permission granting engine(42) may utilize an event authentication which the subscriber control engine 10 may convert to a fixed number of pre-authentication approvals for the user to conveniently use at a future date or set an aggregate financial limit on transactions. These would be accessed by the user through an abbreviated implementation method once approved. This action is beyond the control of the OmniGarda platform 30.

As shown in FIG. 5, 412, in another embodiment of the invention, the user, with approval from the subscriber, may establish a small, storage vault (52) to hide personal data and secrets.

As shown in FIG. 5, 414, in this embodiment, the user would access the vault each time per a pre-determined interval of time using an abbreviated platform protocols through the subscriber control engine 32 to the platform registration engine 36.

What is claimed is:

1) A subscriber-access platform network securely and economically providing virtual (card less and token less) authentication and authorization for a subscriber and the subscriber's users/consumers, said network comprising:
a platform administration engine for monitoring and storing a subscriber's registration protocols and for monitoring and storing library database(s) of randomly collected or anonymously generated samples of personal identity attributes (such as, but not limited to, facial or physical features, finger prints, voice qualities, and medical measurements) which will be made available through secure administrative protocols to the platform;
a registration engine for collecting individual personal identity attributes (such as, but not limited to, facial or physical features, finger prints, voice qualities, and medical measurements) submitted by a subscriber's users/consumers to the subscriber which are combined with a unique alpha-numeric personal identification number (PIN) for each individual user/consumer which will be made available through secure protocols to the sample clarification engine;
a sample clarification engine for editing, formatting, reformatting, disassembling and reassembling the collected individual personal identity attributes samples (such as, but not limited to, facial or physical features, finger prints, voice qualities, and medical measurements) submitted by a subscriber's users/consumers with a unique PIN to meet platform standards for clarity, format, security and utility by the sample scoring engine;
a sample scoring engine for comparing the clarified collected individual personal identity attributes samples (such as, but not limited to, facial or physical features, voice qualities, and medical measurements) submitted by a subscriber's users/consumers with a unique PIN against the entries of library database(s) of clarified randomly collected or anonymously generated samples of like personal identity attributes (such as, but not limited to, facial or physical features, voice qualities, and medical measurements) to generate a secure database of the individual user's/consumer's alpha-numeric scores for each library entry with PIN for evaluation by the permission granting engine;
a permission granting engine for evaluating correlated sets of identical matches of a user's/consumer's alpha-numeric scores with PIN obtained during registration against a user's/consumer's alpha-numeric scores with PIN for individual events when the consumer requests authentication and authorization where the quality and accuracy of said matches provides either a positive or a negative authentication outcome and a message to the subscriber advising subscriber of the outcome;
a personal data vault for stored user/consumer authentication and authorizations as requested by the user/consumer and permissioned by the subscriber and recorded by the platform for future user/consumer initiated events as pre-qualified by a subscriber considering factors such as but not limited to: date, time, elapsed time from a fixed day and time, duration, location, distance from a fixed location and monetary value.

2) The platform network of claim 1 further comprising:
a method to compare third party device measurements of contemporaneous samples of individual personal identity attributes from a known living person with similar samples of personal identity attributes from an established fixed set of stored individual samples from base library(s) using an alpha-numeric scoring scale which captures and records the degree(s) of similarity or dissimilarity.

3) The platform network of claim 1 further comprising:
a method of attaching as data the individual user/consumer alpha-numeric scores of similarity or dissimilarity to the same individual user/consumer assigned a unique personal identification number (PIN) stored in secure database(s), including all known and future commercial databases, including high-speed databases such as JustOneDatabase.

4) The platform network of claim 1 further comprising:
a method of individual authentication which employs matching the unique personal identification number with attached alpha-numeric score values for personal attributes recorded as data in libraries in a registration event with a discrete match of personal identification number with attached alpha-numeric score values for personal attributes against a set of score values stored as data from the library(s) in a authentication event to determine a positive match or the lack of a positive match.

5) The platform network of claim 1 further comprising:
a method which converts a sequence of or a simultaneous set of sufficient positive matches from claim 4 into a secure electronic instruction and record to a subscriber that affirms that the subscriber's individual user/consumer so registered is considered the same as the individual user/consumer seeking event authentication and authorization.

6) The platform network of claim 1 further comprising:
a method which converts a sequence of or a simultaneous set of sufficient non-positive matches from claim 4 in a secure electronic instruction and record to a subscriber that denies that the subscriber's individual user/consumer so registered is the same as the individual user/consumer seeking event authentication and authorization.

7) The platform network of claim 2, wherein a method to compare sequential third party device measurements (such a moving pictures or images, voice recordings and continuously monitored medical data) as “proof of life” for contemporaneous samples of individual personal identity attributes (such as, but not limited to, facial or physical features, finger prints, voice qualities, and medical measurements) from a known living person with similar samples of personal identity attributes (such as, but not limited to, facial or physical features, finger prints, voice qualities, and medical measurements) from an established set of fixed or recorded sequential individual samples from library(s) using an alpha-numeric scoring scale which captures and records degree(s) of similarity or dissimilarity.
